(19) United States
(12) Patent Application Publication
(10) Pub. No.: US 2022/0095543 A1
(43) Pub. Date: Mar. 31, 2022

(54) ELECTRIC FEED BIN SLIDE GATE

(71) Applicant: Joshua Sorenson, Ankeny, IA (US)

(72) Inventor: Joshua Sorenson, Ankeny, IA (US)

(21) Appl. No.: 17/448,905

(22) Filed: Sep. 27, 2021

Related U.S. Application Data
(60) Provisional application No. 63/198,094, filed on Sep. 29, 2020.

(51) Int. Cl. A01F 25/20; A01F 25/16

(52) U.S. Cl. CPC A01F 25/2018; A01F 25/163

(57) ABSTRACT

A bin slide assembly controls the amount of particulate material that is transferred from an agricultural bin, such as a feed bin, to a feed line for delivery for some end use. To allow the control to be automated or otherwise electronically operated, electronic motors can operate one or more slides that selectively block an outlet of the feed bin. The electronic control provides for a more precise operation of the bin slide to control the amount of material. In addition, the use of the electric motor provides a more convenient and easier to operate system. The slides are connected to screws, such as acme screws, which are activated by operation of the electric motor to rotate the screw, which translates the slide between open and closed configurations.

### CROSS REFERENCE TO RELATED APPLICATIONS

This application claims priority under 35 U.S.C. § 119 to provisional patent application U.S. Ser. No. 63/198,094, filed Sep. 29, 2020. The provisional patent application is herein incorporated by reference in its entirety, including without limitation, the specification, claims, and abstract, as well as any figures, tables, appendices, or drawings thereof.

### FIELD OF THE INVENTION

The invention relates generally to the storage and delivery of particulate material and, more particularly, to the storage and delivery of agricultural feed material. More particularly, but not exclusively, the invention relates to a system, apparatus, and/or corresponding method of an electric slide gate for use in selectively delivering an amount of particulate material for a bin, such as a bin containing agricultural feed material.

### BACKGROUND OF THE INVENTION

Agricultural bins are used for a variety of uses. One such use includes the storage of a particulate material, such as feed for livestock. Still other particulates can be stored and delivered, including but not limited to, grains, additives, medications, or the like. The bin includes a storage portion that can be connected to an outlet. The outlet can be fed, such as via gravity, to allow the particulate material to be delivered, dispensed, or otherwise transferred at the outlet.

Typically, the agricultural feed bins include a door or gate at the outlet, with the door or gate selectively opened to allow the particulate material to be dispensed, via gravity, through the outlet. When a determined amount of material has been dispensed, the gate or door is closed. The door or gate is generally a manually operated device in which a user slides or rotates the door or gate to open or close the same. Such a configuration is labor intensive, difficult, and oftentimes inconvenient. This can be based on numerous issues. First, as the bins utilize gravity to move the particulate material, it can be difficult to stop or slow the material to get the door or gate closed. In addition, due to location of the door or gate on the underside of the outlet, the location can be inconvenient for a person to have to work around to access to both open and close. Still further, when the amount to be dispensed is at least somewhat specific, the timing of the closing could be crucial so as to not overfill or deliver too much of the material, such as delivering the correct feed ration from the correct bin during the animal growth cycle. Making sure that a person is watching and quick to act to close the gate or door adds another layer to the difficulty, which includes the timely opening of a new bin when a separate bin runs out of material.

Still additional issues exist with current gates. For example, it takes a lot of time to change a slide. While the actual process takes generally 10-seconds, on some high value (breeding stock mainly) hog farms you often need to shower out of the building, change clothes, move the slide, return to the building, and then shower back in, all for biosecurity. This can be 45-60 minutes to do this 10-second task. Each time a person exits and enters the farm/building that increases the chances they bring a pathogen from outside back into the farm.

Therefore, there exists a need in the art for an improvement to doors and/or gates of gravity fed grain bins in order to make it easier to operate the doors or gates, such as without the need for manual operation.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the invention to improve on or overcome the deficiencies in the art.

It is a further object, feature, and/or advantage to automate the operation of one or more bin slides of a slide assembly of a feed bin.

It is still yet a further object, feature, and/or advantage quickly and easily open or close one or more bin slides.

It is yet another object, feature, and/or advantage to provide a quick and easily installable bin slide assembly.

It is another object, feature, and/or advantage to provide a near infinitely adjustable bin slide door or gate.

The systems and/or apparatus disclosed herein can be used in a wide variety of applications. For example, they can be used to control the output of an agricultural feed bin. In addition, they could be used to control generally any opening or output that allows an amount of material from a bulk storage for some end use.

It is preferred that the bin slide assembly as shown and/or described be safe, cost effective, and durable. The system is generally used in areas of high volumes of particulate material, and should withstand dust, debris, and other particles that could cause breakage of the system.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the invention.

Methods can be practiced which facilitate use, manufacture, assembly, maintenance, and repair of a bin slide assembly as shown and/or described, which accomplish some or all of the previously stated objectives.

The bin slide assembly, including any of the components thereof, can be incorporated into systems, such as existing bins or other bulk storage systems, which accomplish some or all of the previously stated objectives.

According to at least some aspects of some embodiments disclosed herein, a bin slide assembly for an agricultural bin includes a base, at least one slide translationally connected to the base, and a control assembly for translating the at least one slide, with the control assembly comprising an electric motor, and a screw operatively connected to the electric motor and the at least one slide, said operation of the electric motor causing rotation of the screw to translate the at least one slide relative to the base.

According to at least some aspects of some embodiments, the bin slide assembly also includes a first slide and a second slide, and wherein the control assembly comprises a first electric motor and first screw operatively connected to the first slide, and a second electric motor and second screw operatively connected to the second slide.

According to at least some aspects of some embodiments, the first slide and the second slide translate substantially parallel to one another.

According to at least some aspects of some embodiments, each of the first and second slides comprise a slide block in engagement with the first and second screws.

According to at least some aspects of some embodiments, the electric motor comprises an output shaft having a gear.

According to at least some aspects of some embodiments, the control assembly further comprises a second gear, said second gear connected to the screw such that rotation of the second gear causes corresponding rotation of the screw.

According to at least some aspects of some embodiments, the electric motor comprises a brushless DC motor.

According to at least some aspects of some embodiments, the electric motor comprises a brushed DC motor.

According to at least some aspects of some embodiments, the screw comprises an acme screw.

According to at least some aspects of some embodiments, rotation of the acme screw moves the slide 2-mm per rotation of said acme screw.

According to at least some aspects of some embodiments, the electric motor comprises an electric actuator having a threaded rod.

According to at least some aspects of some embodiments, the control assembly further comprises a worm gear operatively connected to the threaded rod of the electric actuator and the at screw, wherein extension of the electric actuator causes the worm gear and screw to rotate to translate the at least one slide.

According to additional embodiments, a feed bin assembly includes a feed bin comprising a housing with an outlet at or near the bottom of the housing, and a bin slide assembly at the outlet of the feed bin to control the output of particulate material from the feed bin. The bin slide assembly comprises at least one slide translationally connected to the base, and a control assembly for translating the at least one slide, with the control assembly comprising an electric motor, and a screw operatively connected to the electric motor and the at least one slide, said operation of the electric motor causing rotation of the screw to translate the at least one slide relative to the base, and wherein operation of the at least one slide controls the output of the particulate material into a feed line.

According to at least some aspects of some embodiments, the feed bin further comprises a feed boot and an unloader at the outlet.

According to at least some aspects of some embodiments, the unloader at least partially encloses the bin slide assembly.

According to at least some aspects of some embodiments, the feed bin assembly further comprises a second bin slide assembly positioned at the outlet of the feed bin.

According to at least some aspects of some embodiments, the second bin slide assembly is positioned side-by-side to the bin slide assembly.

According to at least some aspects of some embodiments, the rotation of the screw in a first direction translates the at least one slide away from the motor, and rotation of the screw in a second direction translates the at least one slide towards the motor.

According to still additional embodiments, a method of opening and closing a bin slide assembly comprises rotating a member in a first direction with a motor, wherein the first direction causes a linear movement of a cover away from the motor, and rotating the member in a second direction with the motor, wherein the second direction causes a linear movement of the cover towards the motor.

According to at least some aspects of some embodiments, the rotating member comprises a screw.

According to at least some aspects of some embodiments, the method further comprises automatically stopping the linear movement of the cover at a distance from the motor.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 is a depiction of an exemplary agricultural feed bin assembly incorporating a bin slide assembly according to aspects and/or embodiments of the present disclosure.

FIG. 2 is an end view of the exemplary agricultural feed bin assembly.

FIG. 3 is a side elevation view of the exemplary agricultural feed bin assembly.

FIG. 4 is a perspective view of a bin slide assembly and feed tubes according to aspects and/or embodiments disclosed herein.

FIG. 5 is another perspective of the bin slide assembly without its cover.

FIG. 6 is an enlarged view of FIG. 5.

FIG. 7 is a top plan view of FIG. 6.

FIG. 8 is a perspective view of an exemplary bin slide assembly according to aspects and/or embodiments of the present disclosure.

FIG. 9 is a top plan view of the bin slide assembly of FIG. 8.

FIG. 10 is an end view of the bin slide assembly.

FIG. 11 is a top plan view showing components of the bin slide assembly.

FIG. 12 is a bottom plan view showing components of the bin slide assembly.

FIG. 13 is a view of a portion of the agricultural feed bin assembly showing the outlet and bin slide assembly.

FIG. 14 is an end view of FIG. 13.

FIG. 15 is a perspective view of a bin assembly with a twin boot setup and multiple bin slide assemblies.

FIG. 16 is a perspective view of a twin bin slide assembly and feed lines.

FIG. 17 is a top plan view of FIG. 16.

FIG. 18 is an end view of FIG. 16.

An artisan of ordinary skill need not view, within isolated figure(s), the near infinite number of distinct permutations of features described in the following detailed description to facilitate an understanding of the invention.

### DETAILED DESCRIPTION OF THE INVENTION

The present disclosure is not to be limited to that described herein. Mechanical, electrical, chemical, procedural, and/or other changes can be made without departing from the spirit and scope of the invention. No features shown or described are essential to permit basic operation of the invention unless otherwise indicated.

Unless defined otherwise, all technical and scientific terms used above have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “present invention” or “invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

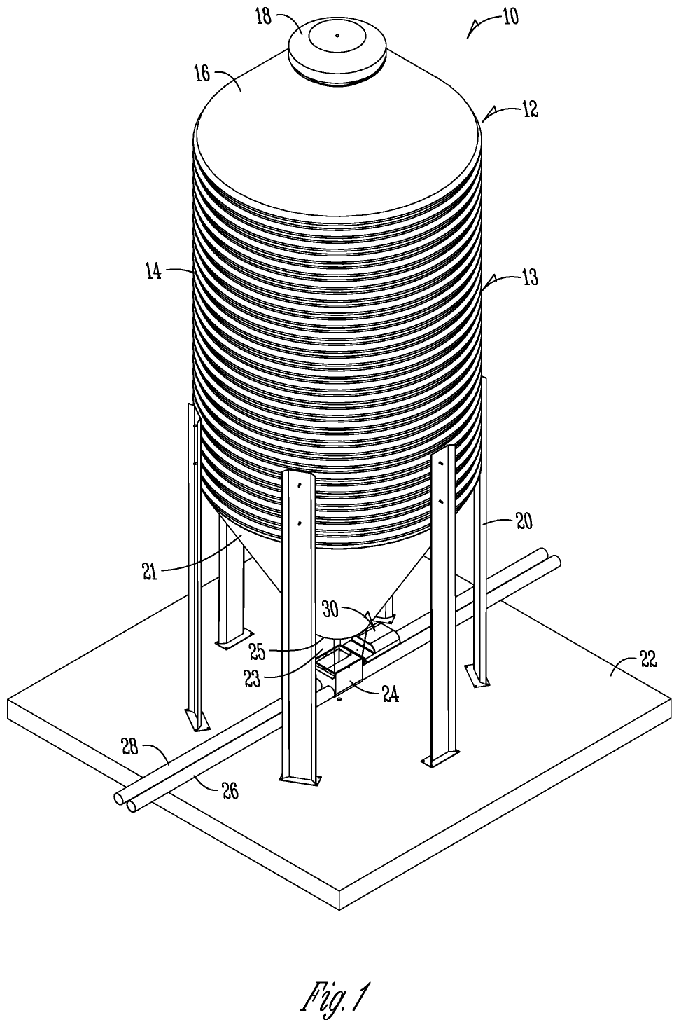

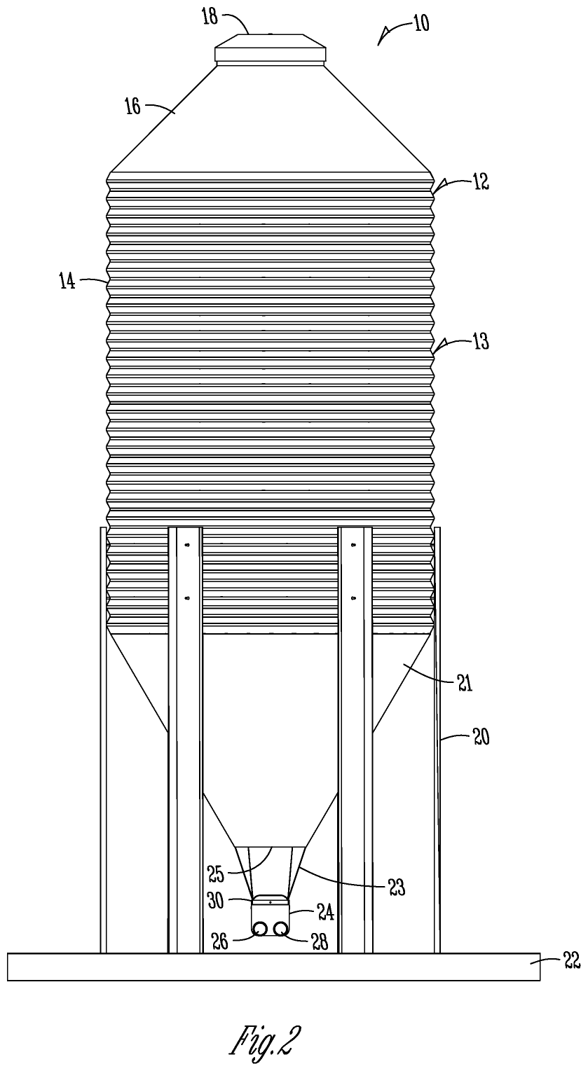

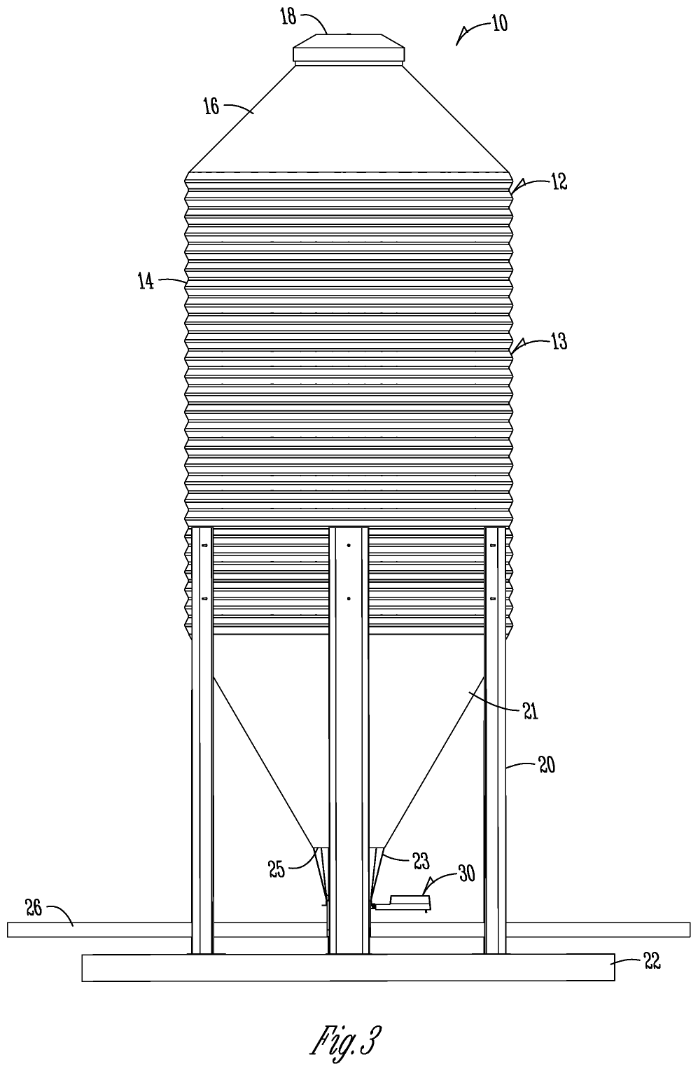

Referring now to the figures, a feed bin assembly 10 is shown in FIGS. 1-3. The feed bin assembly 10 is an apparatus or system which is used to store an amount of bulk particulate and/or granular material, such as feed for livestock or the like. The bin assembly 10 includes a feed bin 12 which includes a housing 13 comprising ribbing 14 to store the material therein. The housing 13 can be generally of any size and/or shape, but is shown to be generally circular and/or cylindrical in the figures. At an upper portion of the housing 13 is a top cone 16 and a cover 18. The cover 18 encapsulates an opening in which the feed bin 12 can be loaded and/or added with particulate or granular material. At a lower end of the housing 13 is a bottom cone 21. The bottom cone is shaped to direct the particulate and/or granular material in the housing 13 of the bin 12 towards an outlet 25. A plurality of legs 20 are positioned generally around the outer portion of the housing 13 and support the housing in the upright position shown in the figures. It should be noted that, while a feed bin of cylindrical shape and height is shown in the figures, it is not to be limiting and/or dispositive on the invention, as will be understood. However, for exemplary purposes, such a feed bin will be used in conjunction with the invention as disclosed.

At a lower end of the lower cone 21 is a feed boot 23 and an unloader 24. As is known, the particulate material is fed generally by gravity in the housing 13 of the feed bin 12 to move the particulate material into the bottom cone 20 and further into the feed boot 25 and unloader 24. As will be understood, the unloader 24 is used in conjunction with a bin slide assembly 30 to selectively allow an amount of material from the housing 13 of the feed bin 12 into one or more feed lines. As shown in the figures, the bin assembly 10 includes a first feed line 26 and a second feed line 28. The feed lines receive an amount of particulate material from the feed bin 12 and then direct the material to a separate location, such as for use. For example, the feed lines may be associated with feeding troughs or feeding locations for different livestock in different locations, such that the first feed line 26 is incorporated with the first location, and the second feed line 28 is associated with a second location. Furthermore, it should be appreciated that the number of feed lines is not to be limiting, and a second feed line or even additional feed lines could be associated with a feed bin and incorporated with the bin slide assembly 30 as will be disclosed herein.

Still further as is shown in the figures, a concrete slab 22 is shown to be supporting the plurality of legs 20 of the bin assembly 10. The concrete slab 22 provides support for the bin assembly 10 and to withstand and hold the weight of the assembly 10.

The feed bin assembly 10 includes a bin slide assembly 30 associated with the feed boot 23 and the unloader 24. The bin slide assembly 30 includes one or more slides which are selectively opened and closed to allow the particulate material being gravity fed through the bin assembly into the one or more feed lines. For example, when no material is needed to be directed towards an end use location, the one or more slides of the bin slide assembly 30 can be in a generally closed position such as to not allow the material to be directed or otherwise allowed into the one or more lines. When, in an on-demand situation, the material is needed, such as during feeding or the like, the one or more slides can be opened to allow the material to be passed from the feed boot 23 out of the outlet 25 and into the unloader 24, where it is positioned in one of the feed lines 26, 28, where it can be directed towards the end use location.

It is noted that, while the figures may show a bin slide assembly 30 with two slides, this is not to be limiting. For example, there are many assemblies that only include a single slide, and this could be operated using the components shown and/or described herein, as would be understood by one skilled in the art. Thus, one or more slides can be used with any slide assembly according to the components disclosed, and all should be considered part of the invention.

While the feed lines can be used for feeding or directing material for feeding, it should be appreciated that the end use can be other purposes. In some examples, the feed lines can direct the material to an end use wherein the material is further manipulated, mixed, or otherwise used for another purpose.

As noted, traditionally, bin slides have been manually operated such that they must be manually opened or closed upon demand. However, the invention, as will be understood, includes an electrical and automated bin slide assembly 30, wherein the opening and/or closing of the one or more slides of the bin slide assembly 30 can be automated such that no manual operation is required. This can be on a timer, can be connected wired or wirelessly (e.g., such as via a remote control), can include a switch or switches, can be set via a timer to operate at predetermined times, or can otherwise be operated such that a user need not manually open and/or close, and instead, can rely on one or more motors to automatically open or close the one or more slides.

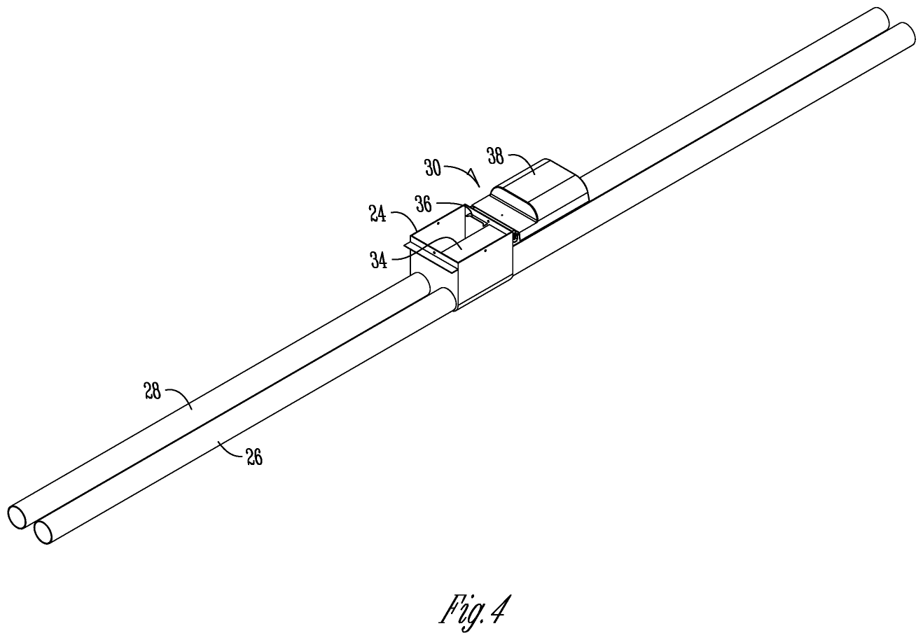

Therefore, as is shown in FIGS. 4-7, a bin slide assembly 30 is shown in conjunction with the first and second feed lines 26, 28. As shown, the bin slide assembly 30 will generally be positioned along the feed bin lines such that the feed bin line 26, 28 will pass generally through the unloader 24. The unloader includes an open upper portion and the bin slide assembly 30 includes, in this exemplary example, two bin slides 34, 36, which can be selectively opened and closed via electric motors 42, 44 to automatically and/or hands free open and/or close to allow an amount of particulate and/or granular material to enter the unloader 24, where it is positioned in the one or more feed lines 26, 28, where it can be directed towards an end use location.

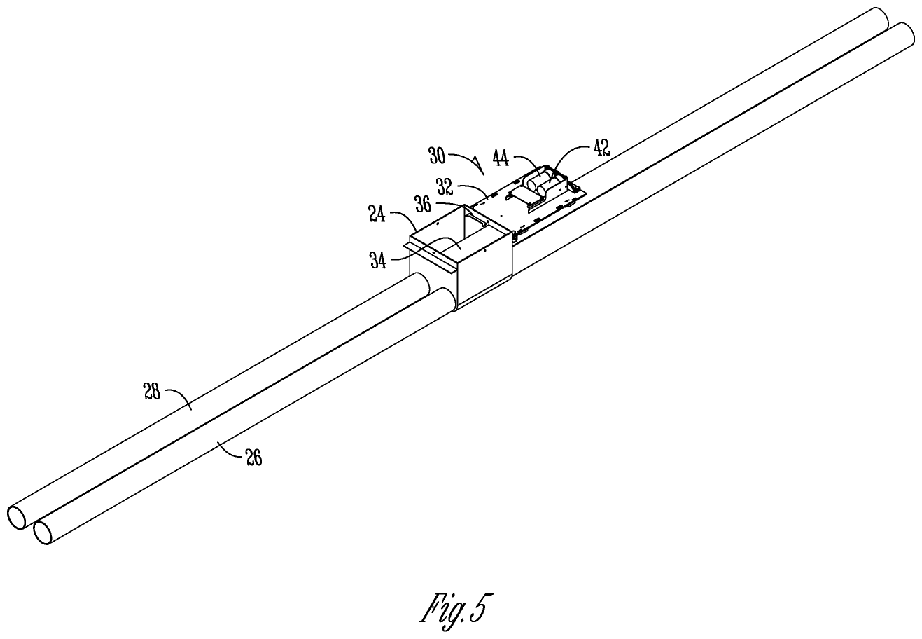

FIG. 4 shows the bin slide assembly 30 with the cover 38 covering the internal components, while FIGS. 5-7 show the cover 38 removed. The cover 38 is utilized to mitigate dust and/or other particles from the internal portion of the bin slide assembly 30, which will allow the components to move and operate more efficiently. In addition, it should be noted that the figures show a first slide 34 in a generally closed position and a second slide 36 and generally opened position. The terms opened and closed refer to the condition wherein a closed position, such as slide 34, material is not allowed to enter the unloader 24 and thus the first feed line 26. However, with the open configuration of the second slide 36, material would be allowed to enter the unloader 24 and be introduced into the second feed line 28, where it can be directed towards an end use location.

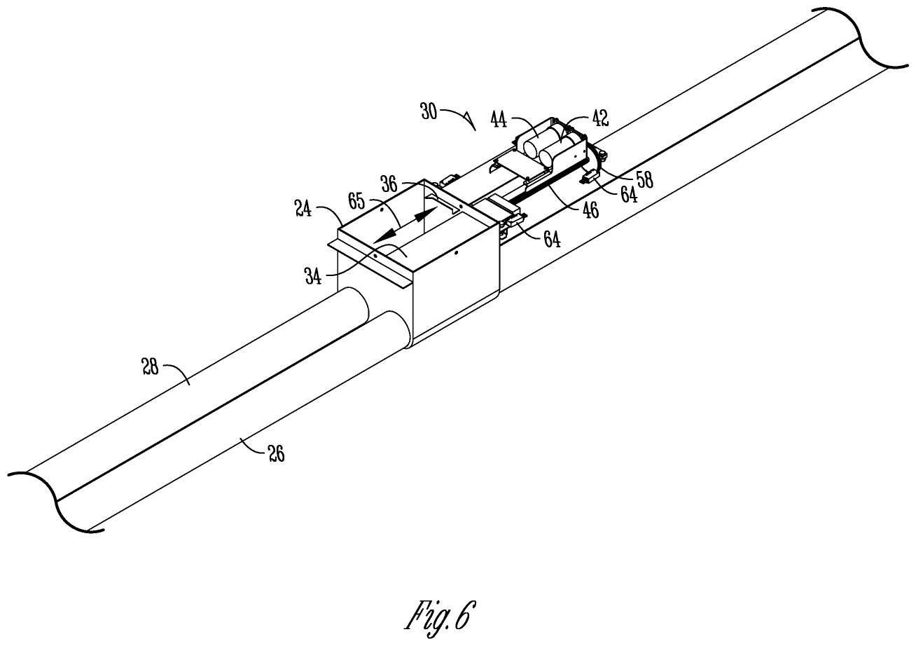

As noted, in order to operate the translational movement of the slides, which is shown generally by the arrow 65 in FIG. 6, an electric motor or motors can be associated with each of the slides. For example, a first electric motor 42 is associated with a first slide 34 and a second electric motor 44 is associated with the second slide 36. As will be understood, the electric motors 42, 44 are operatively connected to the slides 34, 36, which converts rotational output of the motors into the translational movement in the directions 65 as shown by the arrow 65 in FIG. 6. This translational movement is generally open or closed with respect to the unloader 24, which will selectively allow an amount of material to enter the unloader 24 and thus the feed lines 26, 28.

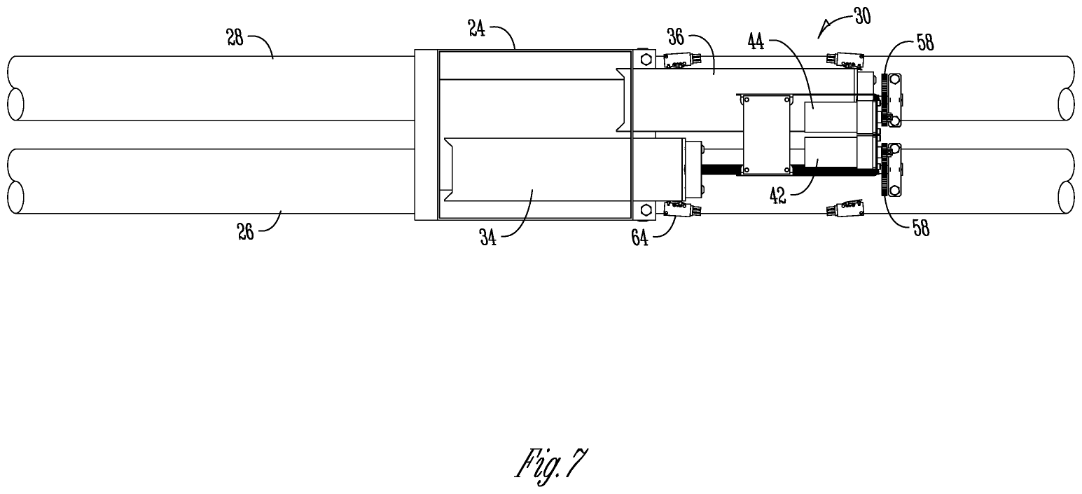

As shown in FIG. 7, which is a top plan view of the exemplary system, the first slide 34 is again shown in a generally closed position, with the second slide 36 in a generally open position. As noted, in this configuration, particulate material would be allowed, via gravity, to pass into the unloader 24 to be entered into the second feed line 28 only.

In addition, as is shown in FIGS. 6 and 7, the bin side assembly 30 can include a number of sensors 64. The sensors provide limits, thresholds, or the like in which the translational movement of the slides 34, 36 are able to move. For example, it is noted that the sensor 64 are touch or contact sensors and the configuration shown. The movement of the slides in the direction of the arrow 65, which is generally a translational direction, will be allowed until a portion of the slide 34, 36 comes in contact with a portion of the sensor 64. This will automatically stop the activation of the motors 42, 44, which indicates a threshold limit of movement for the slides 34, 36.

It is noted that the configuration in FIGS. 6 and 7 include fully opened and fully closed positioned sensors, which would indicate full or open movement of the slides. However, it should be appreciated that the slides would be able to be opened or closed generally infinitely along the opening of the unloader 24 and it is not necessarily limiting that they can only be in a fully opened or fully closed positioned. Additional sensors could be included, or operation could be controlled, such as via a switch, button, tablet, predetermined algorithm and/or control, or the like, wherein the slide is opened less than full or closed less than full so as to allow a limited amount of material to enter the unloader to be added and moved via the feedlines 26, 28.

While it is not to be limiting, the type of sensor and control of the slides could be controlled in a number of ways, including, but not limited to, the Hall effect, magnetic sensors, proximity sensors, light sensors, infrared (IR) sensors, sound sensors, time/amps based control, and/or rotary encoders. Still further, a flow sensor could be included in the bin assembly 10, such as downstream from a particular bin slide assembly 30. The flow sensor (e.g., flow meter) could sense the amount of feed in an auger of the system, such as a percentage full. This information could then be communicated to the bin slide assembly 30, where the screw or screws could be activated, either fully or incrementally in an open or closed manner to control the amount of additional material that is allowed to be directed into the system. This monitoring and feedback could continue as needed.

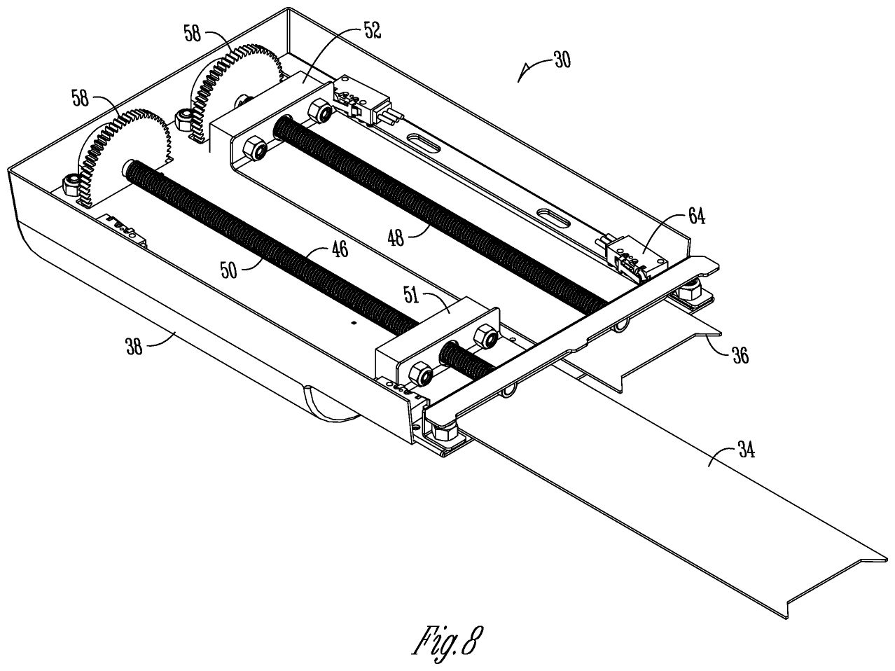

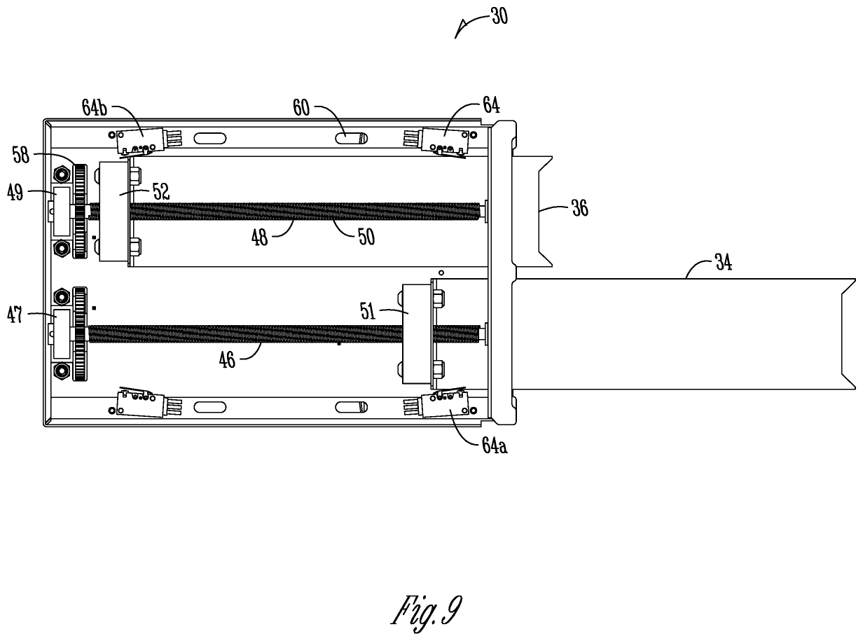

FIGS. 8 and 9 are close up views of the underside of the bin side assembly 30 according to embodiments of the invention. The figures show additional details providing a way for the slides to move in the translation direction of the arrow 65, as has been shown and described. As noted, an electric motor, such as the motors 42, 44 are associated with the slides to allow for the electrical movement thereof. The motors can be generally any type of electrical motor, including but not limited to brushless DC motors (BLDC). However, it should be appreciated that other types of electric motors including but not limited to stepper motors, AC motors, other DC motors (including both brushed and brushless DC motors), and the like could be utilized with the invention. The exact type of electric motor is not to be limiting thereof. In addition, according to at least some embodiments, the motors are operated at substantially low voltage, which can be 24-volts or similar voltage.

In some embodiment, the electric motor is driven by a motor driver or other power source, which is coupled to the electric motor via associated wires. A control mechanism, such as an air pump, electrical switch, or the like, may be provided for controlling the motor driver or power supply. For example, a control circuit may control and adjust the rotational speed of electric motor and a magnetic drive member. The control circuit may also be configured to actuate the electric motor when a pumping mechanism is magnetically coupled to the driving mechanism and to act as a safety switch to stop actuation of the electric motor when the pumping mechanism is not magnetically coupled to the driving mechanism or when there is a relatively weak magnetic coupling between the pumping mechanism and the driving mechanism, suggesting misalignment.

The electric motor may be covered by a magnetically permeable material, such as steel, which is typically attached to and covers opposite ends of the electric motor to shield the electric motor from magnetic flux.

It is noted that the motors are located generally on top of the assembly 30. Having the motors at this location allows for the components to be generally self-contained and aids in keeping the size of the system minimal. As will be understood, this can be advantageous, such as when positioning multiple assemblies adjacent one another on a twin boot setup of a bin assembly.

The motors have a rotational output. The rotational output of the motor is operatively connected to the slides 34, 36 to translate the rotational motion of the output into a generally translational and linear movement of the slides in a longitudinal direction of the slides. For example, as shown in the figures, the slides 34, 36 are attached to screws 46, 48. The screws 46, 48 can be referred to generally as leadscrews. A leadscrew (or lead screw), also known as a power screw or translation screw, is a screw used as a linkage in a machine, to translate turning motion into linear motion. However, the exact type of screw is not to be limiting to the invention.

The screws shown in the figures are acme screws. In general, acme screws use a trapezoidal-shaped thread to roll on to the lead screw. As the shaft rotates due to the rotation from the electric motor, the threads push a device, such as slide blocks 51, 52 along the length of the threaded shaft. The rotation transfer rotational force from the motor into linear motion of the slide blocks 51, 52. As the slide blocks are connected to the slides 34, 36, the movement of the slide blocks on the threaded portion 50 of the acme screws 46, 48 will allow for the slide blocks to move in the linear directions, which constitutes a translational movement, such as that of the arrow 65 as shown in the figures.

The slide blocks 51, 52 are essentially a lead screw “nut”, which moves due to the rotation of the screw(s). Thus, the rotation of the screw(s) causes the slide blocks/nuts to move there along, and as they are connected to the slides, the slides will correspondingly move as well in the linear direction.

According to an exemplary aspect of the invention, the acme screws 46, 48 include movement which is two millimeters per revolution of the screw. What this means is for every revolution of the screw caused by the electric motor, the slides 34, 36 and slide blocks 51, 52 will move two millimeters. However, the threads of the screws 46, 48 could be changed in order to provide for more or less movement per revolution.

Furthermore, as shown in FIG. 9, the first slide is extended with a portion of the first slide block 51 contacting a sensor 64a, which indicates a threshold movement to fully or substantially fully close the first slide 34. In addition, it is noted that the second slide 36 and associated second slide block 52 is generally positioned at and contacting a different sensor 64b, which indicates another limit to position the slide 36 and a fully or substantially fully opened configuration. Again, it is noted that the sensors can be positioned generally anywhere along the length of the slides and/or screws to allow for the near infinite opening and closing of the slides 34, 36 according to the length of the screws. Alternative sensors could be mounted in other places, for example counting revolutions of the gear, or just measuring the motor amps.

Additional aspects of the bin slide assembly 30 shown in the figures include apertures 36 to allow for the installation of the bin slide assembly with the feed bin assembly 10.

In addition, as will be understood, a control assembly 40 is included with the bin slide assembly 30 to control the movement of the slides 34, 36. The control assembly 40, according to some aspects or some embodiments, include a first bearing 47 and a second bearing 49. The bearings 47, 49 are associated with the screws 46, 48, which allow for less resistance for the rotation of the screws. Generally opposite the bearings are bushings 62 to allow for the generally unopposed movement of the screw upon activation of the motors. In addition, the figures show screw gears 58 connected to the screws 46, 48. As is shown, the gears 58 and the screws 46, 48 generally share a rotational axis. Therefore, rotation of the gears 58 will cause similar rotation of the screws 46, 48. As will be understood, the gears 58 can be sized (such as by the number of gear teeth or the like) to receive the rotational output from the electric motor and to cause a desired rotational speed of the screws 46, 48, which in combination with the threading 50 of the screws, will control the rotational speed of the screws, and thus the translational and/or linear movement speed of the slides 34, 36.

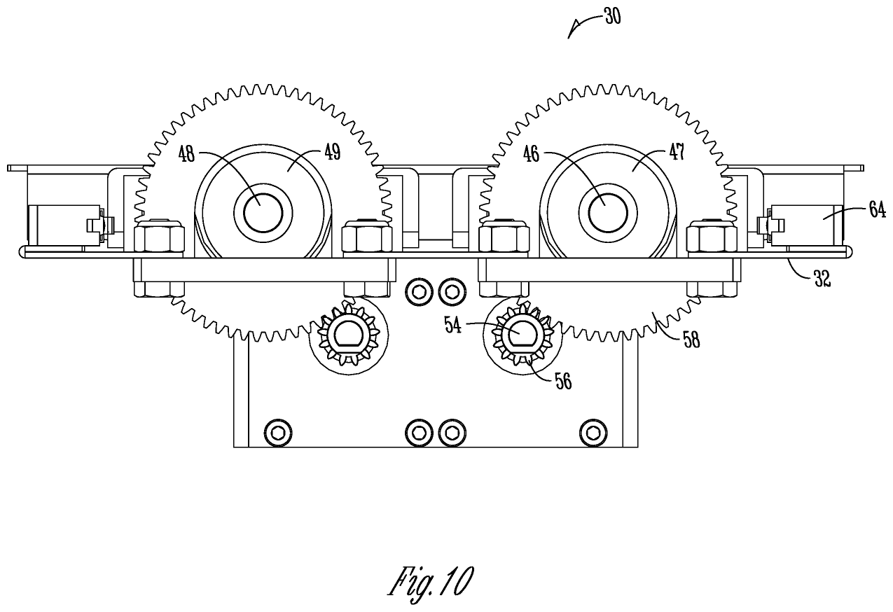

Therefore, as is shown in FIG. 10, aspects of the control assembly 40 of the bin side assembly 30 is provided. As noted, and shown throughout the figures, first and second motors 42, 44 are provided to provide for an output. As noted, the motors can be electrically operated. The motors include output shafts 54, which is generally identical for both motors and therefore only shown with respect to one of the motors in FIG. 10. The output shaft provides a rotational movement. The output shaft is fitted with an output shaft gear 56 including a number of gear teeth thereon. Thus, the rotation of the output shaft 54 will cause similar rotation of the output gear 56 caused by the activation of the electrical motors 42, 44.

As shown best in FIG. 10, the gear teeth of the gear 56 correspond and engage with the gear teeth of the screw gear 58. Therefore, the rotation of the output shaft 54 and thus rotation of the output gear 56 will cause the corresponding movement of the screw gear 58. As is known, the size and number of gear teeth between the output gear 56 and thus the driven gear 58 can control the speed of the rotation of the gear 58 which then controls the rotational speed of the screws 46, 48, which controls the translational and/or linear movement of the slides 34, 36. According to an exemplary example, the electrical motors will have a 400 rpm output, which is geared down to slow the rotation of the screws. According to at least one example, the output can be geared down to open and/or close the slides from a fully closed to a fully open and/or oppositely, in approximately one minute. However, this can be changed according to any of inputs including but not limited to, the rotational output speed of the motors, the ratio of the drive gear 56 and the driven gear 58, and/or the size and/or number of threading of the screws 46, 48.

Still further, while the direct drive and driven gears 56, 58 have been shown in the figures, it should be appreciated that other types of gears in gear systems could be included. For example, a worm gear of the like could be associated wherein the output shaft 54 and drive gear 56 of the electrical motors could be varied so as to correspond with a worm gear associated with the screws, wherein the worm gear rotation causes like rotation of the screws, which causes linear and/or translational movement of the slides. Any other general type of gear configuration is considered to be included and part of the invention.

Still further, it should be appreciated that gears are not required in all situations and/or configurations of any of the aspects of any of the embodiments disclosed. Instead, it is to be appreciated that the motor or other drive mechanism could be directly attached to the end of the screw without gears. The rotation of the motor/drive member would directly rotate the screw, which would operate in generally the same manner as when gears are used.

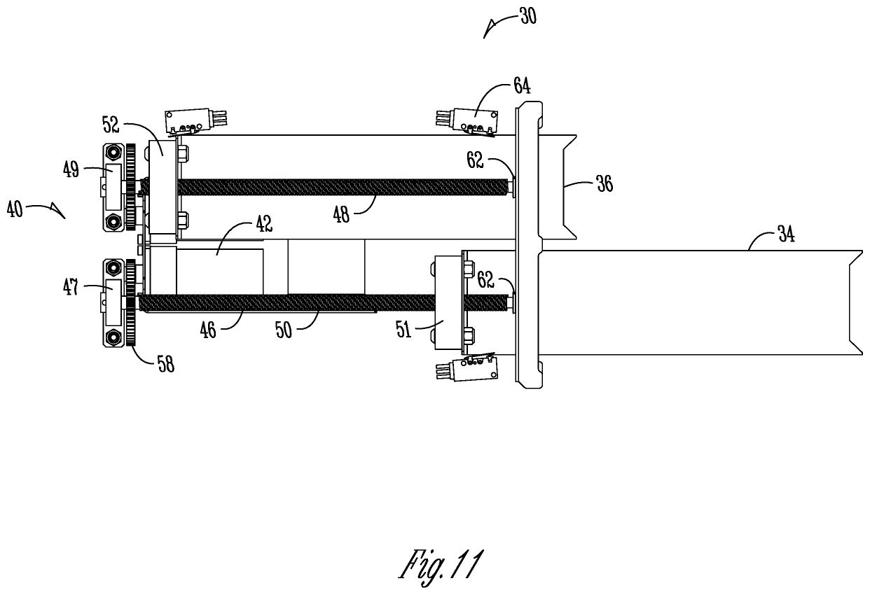

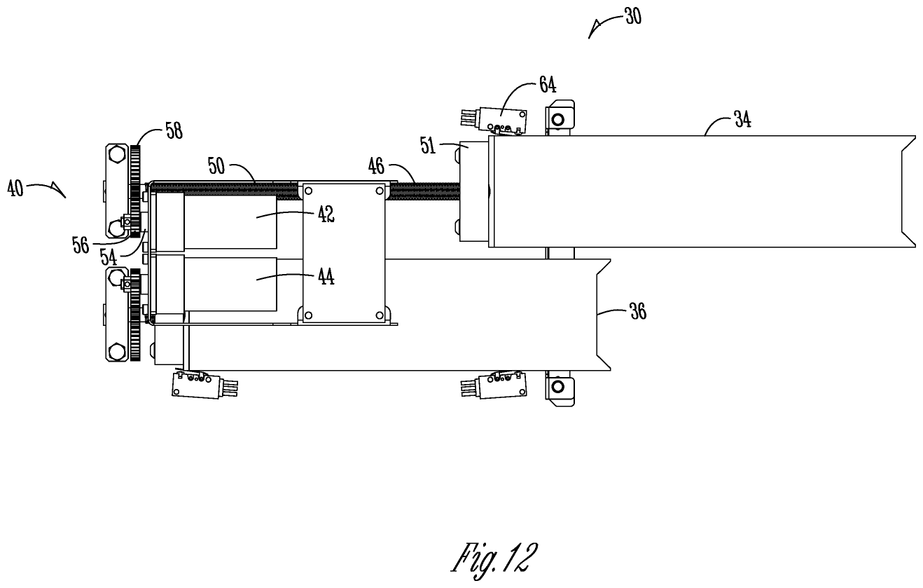

FIGS. 11 and 12 show additional aspects of the bin slide assembly 30 with components removed. FIG. 11 is another bottom view and FIG. 12 is a top view of the bin slide assembly 30. As shown in FIG. 12, the first and second motors 42, 44 are shown. This shows the output shaft 54 and drive gear 56 in conjunction with the driven gear 58 associated with the screws 46, 48. In addition, FIG. 11 shows the location of the bushings 62 at a distal end of the screws 46, 48. As noted, the combination of the bearings 47, 49 and the bushings 62 allow for an easier rotation of the screws, which provide for a smooth linear movement of the slides 34, 36 during operation of the control assembly 40 of the bin slide assembly 30.

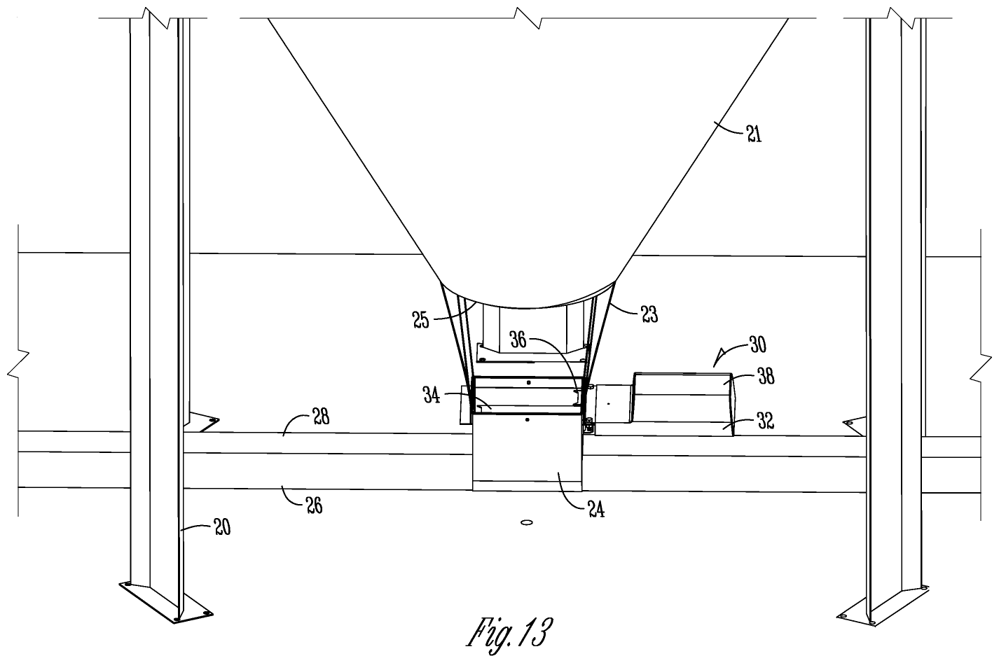

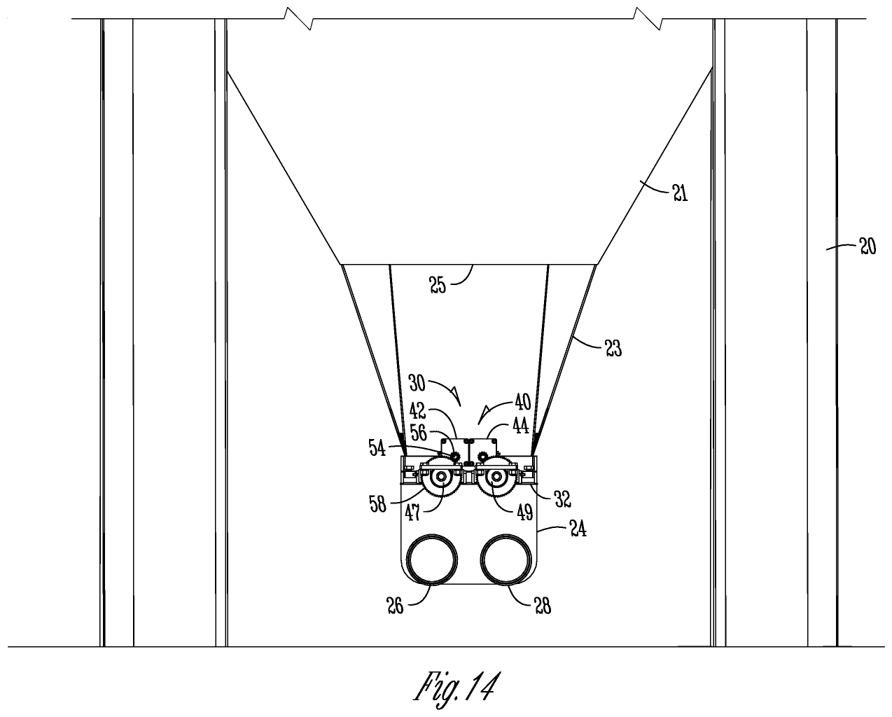

FIGS. 13 and 14 show additional views of the bin slide assembly 30 in conjunction with the feed bin assembly 10. As shown in FIG. 13, the first slide 34 is in a generally closed configuration while the second slide 36 is in a generally open configuration. As noted, this configuration shown provides that the second slide 36 has been linearly translated along the screw to retract the slide 36 generally into the assembly 30, which allows for an amount of particulate material to be transferred from the feed bin 12 and into the uploader 24 and further into the feed line 28. The closed slide 34 will mitigate any transfer of material from the feed bin into the feed line 26.

FIG. 14 shows an end view of the feed bin assembly 30 with the unloader 24 and feed lines 26, 28, wherein aspects of the feed bin assembly have been removed. For example, the cover 38 has been removed to show the internal components of the feed bin assembly 30. As noted, first and second electrical motors 42, 44 include rotational output shafts 54 have a drive gear 56 positioned generally thereon. Thus, operation of the first and second motors will cause corresponding rotation of the drive gears 56. The drive gear 56 is in engagement with a driven gear 58, which is generally connected and positioned on the screws of the assembly. Therefore, rotation of the drive gear 56 will cause a correspondingly rotation of the driven gear 58. This will also rotate the screw, such as with assistance of the bearings 47, 49 and bushings 62, which will move the slide blocks 51, 52 associated with the slides 34, 36. The movement of the slide blocks on the screws will cause linear translation of the slides, which will open and/or close the slides according to the rotational direction of the output shaft 54 and thus gears 58.

Therefore, as noted, the feed slide assembly 30 could be controlled in a number of ways. It is noted that the electrical motors can be generally low voltage, which can be approximately 24 volts to operate. To operate the electrical motors, any number of ways can be included. For example, in wired configurations the electrical motors could be operatively and electrically connected to a switch or switches. For example, two switches (not shown) could be provided. A first switch could be associated with the first motor 42 and a second switch could be associated with a second switch 44. The switches could have three configurations. In a neutral state, no operation of the motor will be activated. However, movement of the switch in the first direction could cause the operation of the motor in a first direction, such as to open the slides. However, movement of the switch in the opposite direction on the opposite side of neutral and towards a second direction could cause reverse rotation of the motor, which could close the slide based on the rotation direction of the output shaft of the motor. Furthermore, the switch could be one directional and the sensor 64 provided could be programmed to understand which direction the motors need to rotate to open and/or close the slides. For example, as noted, generally threshold sensors were positioned on opposite proximal and distal portions of the screws. Programming could realize at which proximal or distal sensor the slide block is associated, and activation of the switch could automatically sense and control the rotational direction of the output shaft of the motor so as to move the slide block in either the opened or closed direction accordingly.

Even further, the operation of the motors 42, 44 could be controlled wirelessly, such as via a handheld, a tablet, a phone, remote control, or the like, wherein a selective direction of the slides could be chosen and/or controlled via the handheld and/or wireless or wired remote control. This could allow for the near infinite movement in the linear direction as well as the slides wherein the control could operate the motor for such time that the corresponding slide has opened and/or closed to the desired location, wherein the operation could be seized, which could stop the operation and allow for the operation of the bin assembly. Therefore, the invention should not be limited to such operations, but should be understood to be electrically controlled such that the slides could be easily and controllably opened and/or closed as needed for operation of the feed bin assembly.

It is noted that, due to the way the slides are moved, the size of the bin slide assembly 30 will be advantageous in use. For example, using electric motors with rotary outputs, as opposed to linear actuators, allows the transfer of the rotary movement to the linear translational movement of the one or more slides. Therefore, the only externally moving parts of the assembly 30 is the slides themselves, which are intended to be moved to open or close access into the unloader of the system. This is a type of self-contained system, which provides numerous advantages. Keeping the external movement based on the rotary output instead of any actuator provides additional benefits. For example, an exemplary version of the bin slide assembly 30 as provided may be an approximately 13″ long device that has approximately 9.6″ of slide travel. A linear actuator system may need to be 23″ or longer to provide 9.6″ of travel. Therefore, the bin slide assembly 30 can be kept to a smaller size, at least partially based on the rotary to linear movement.

Still another advantage of the bin slide assembly 30 as shown and/or described relates to the installation thereof. Most bins of bins assemblies 10 contain an amount of material, making it less than ideal to swap out components. However, with the bin slide assembly 30 as shown and/or described, the boot 23 does not have to be removed, and the system can simply be placed inline with the feed lines and in conjunction with the feed boot 23 and unloader 24. Even further, it should be appreciated that the bin slide assembly 30 can be installed at the inlet or outlet end of the feed boot 23, which allows passage of the material into the unloader and thus, feed lines.

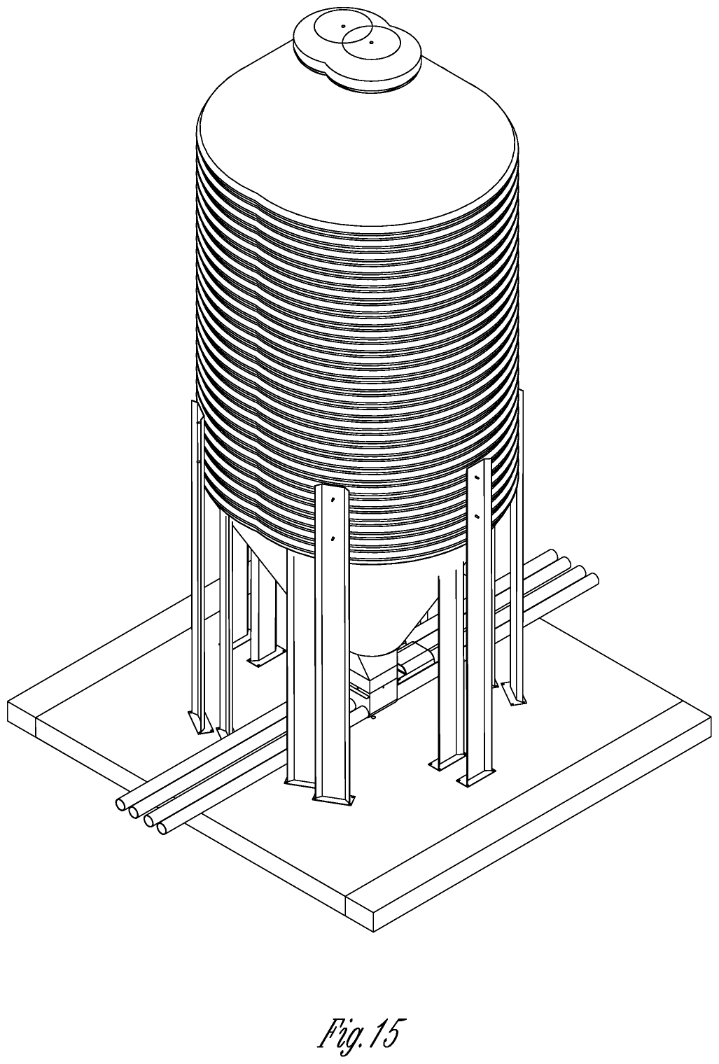

FIG. 15 is a depiction of another bin assembly showing a setup with a twin boot setup. A twin boot setup is a system in which there are essentially two feed boots 23A, 23B, which increases the load into the feed bins. As is shown, there are four feed bins for receiving the material from the feed bin.

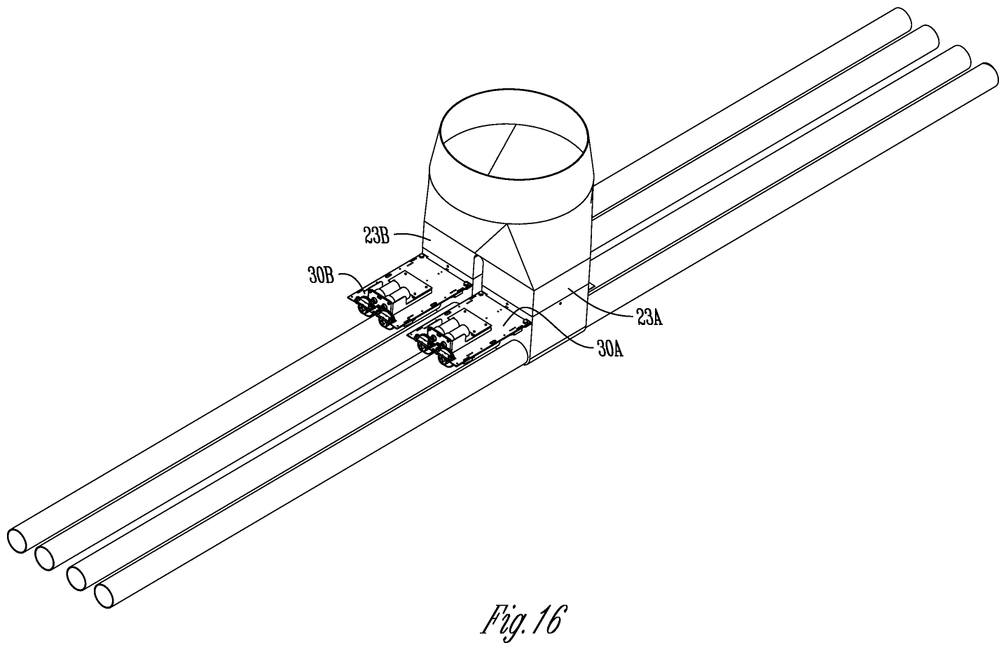

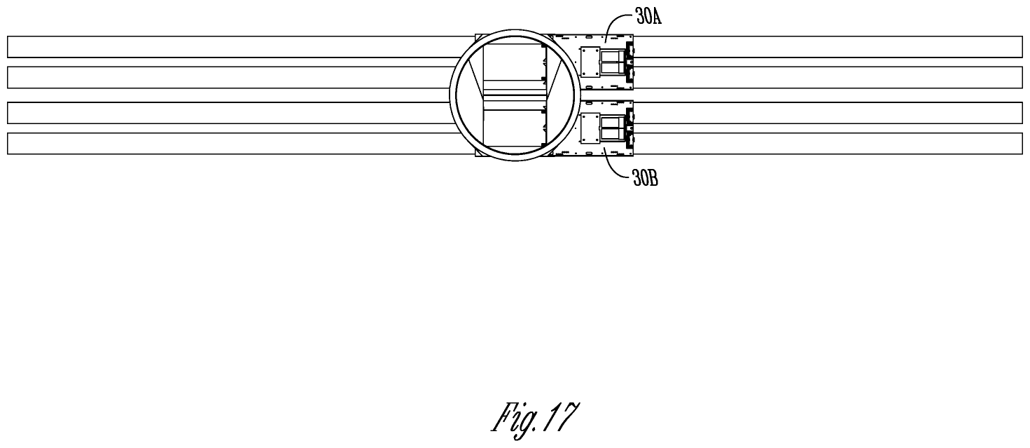

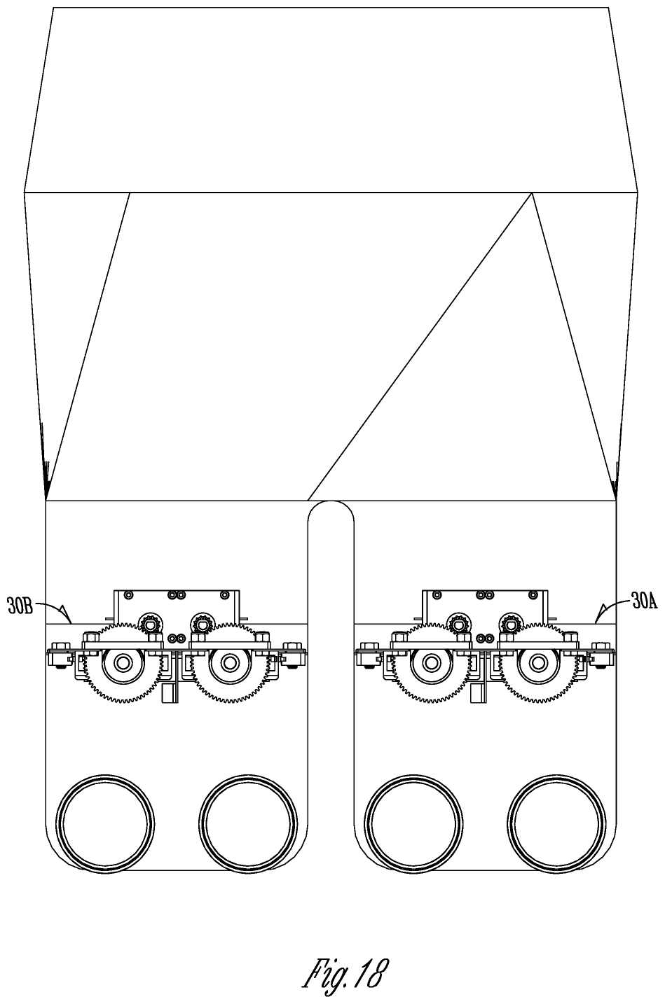

As best shown in FIGS. 16, 17, and 18, two bin slide assemblies 30A, 30B are associated with the twin feed boot to selectively allow material into the four feed lines. The two bin slide assemblies 30A, 30B are generally identical to one another and to that shown and described previously herein.

As is shown, an advantage of the bin slide assemblies 30A, 30B is that they are able to be positioned side-by-side and in generally the same location to one another with respect to the feed lines. This is due, at least in part, to the location of the motors being on top of the base of the assemblies. The top mounted motors and the corresponding transfer of rotary movement to the linear movement of the slides keeps the size of the assemblies to a minimum. There is generally nothing sticking outside of the self-contained system that would prevent such a twin usage of multiple bin slide assemblies. In other systems, such as those with actuators, the size and location of the actuators limits the location of the mounting of multiple systems, which makes them less ideal.

According to at least some aspects of some embodiments, any of the bin slides and/or assemblies shown and/or described could include automation and other controls. For example, one or more embodiments described herein can be controlled and/or operation using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

In such embodiments, the automated bin slide assemblies will preferably include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

It is further included that the bin slides could include a processing unit. A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

The memory can include any of the instructions, databases, controls, or other logic as may be included to operate the bin slide in such an automated fashion. This could be set to be on a timer or connected to a control to allow for remote usability of the system.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

Furthermore, in any of the embodiments disclosed, the bin slide assembly could be hard wired or battery-operated. In other words, there is a power supply to operate the electronics. The power supply outputs a particular voltage to a device or component or components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (“LSD-NiMH”) battery, a nickel-cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

Still further, it is to be understood that the system could include an interface to control any of the bin slides as included herein. This could be attached to the bin slides, or could be done remotely, such as in a wireless manner. The interfaces could operate the systems in real time, or could provide instructions and or other automation to allow the bin slides to operate in a remote and automated manner.

A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

The sensors, as disclosed herein, could be of many types. The sensors sense one or more characteristics of an object and can include, for example, accelerometers, position sensors, pressure sensors (including weight sensors), or fluid level sensors among many others. The accelerometers can sense acceleration of an object in a variety of directions (e.g., an x-direction, a y-direction, etc.). The position sensors can sense the position of one or more components of an object. For example, the position sensors can sense the position of an object relative to another fixed object such as a wall. Pressure sensors can sense the pressure of a gas or a liquid or even the weight of an object. The fluid level sensors can sense a measurement of fluid contained in a container or the depth of a fluid in its natural form such as water in a river or a lake. Fewer or more sensors can be provided as desired. For example, a rotational sensor can be used to detect speed(s) of object(s), a photodetector can be used to detect light or other electromagnetic radiation, a distance sensor can be used to detect the distance an object has traveled, a timer can be used for detecting a length of time an object has been used and/or the length of time any component has been used, and a temperature sensor can be used to detect the temperature of an object or fluid.

Furthermore, when the system is set up with an interface, it is to be understood that the interface could be in wired or wireless communication with one or more bin slide assemblies, so as to check status, operate, or provide instructions for automated control thereof. Such wired or wireless connection and communication between an interface and the bin slide assemblies could take many forms, and are not to be limited to that specifically disclosed.

In some embodiments, the network is, by way of example only, a wide area network (“WAN”) such as a TCP/IP based network or a cellular network, a local area network (“LAN”), a neighborhood area network (“NAN”), a home area network (“HAN”), long range network (“LoRa”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

For wired connections, Ethernet could be used. Ethernet is a family of computer networking technologies commonly used in local area networks (“LAN”), metropolitan area networks (“MAN”) and wide area networks (“WAN”). Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Ethernet was first standardized under the Institute of Electrical and Electronics Engineers (“IEEE”) 802.3 working group/collection of IEEE standards produced by the working group defining the physical layer and data link layer's media access control (“MAC”) of wired Ethernet. Ethernet has since been refined to support higher bit rates, a greater number of nodes, and longer link distances, but retains much backward compatibility. Ethernet has industrial application and interworks well with Wi-Fi. The Internet Protocol (“IP”) is commonly carried over Ethernet and so it is considered one of the key technologies that make up the Internet.

Therefore, a bin slide assembly 30 for use with a feed bin assembly has been shown and/or described. It should be appreciated that any of the components of any of the aspects and/or embodiments disclosed herein could be combined with any of the other aspects or embodiments to create additional aspects and/or embodiments, which are not explicitly shown and/or described herein, but which are part of the invention. Still further, while some components have been described herein, it should be appreciated that once any alternative, or similar component obvious to once skilled in the art should be considered to be a replacement component for the invention, and therefore should also be considered part of the invention.

1. A bin slide assembly for an agricultural bin, comprising:
a base;
at least one slide translationally connected to the base; and
a control assembly for translating the at least one slide, the control assembly comprising:
an electric motor; and
a screw operatively connected to the electric motor and the at least one slide, said operation of the electric motor causing rotation of the screw to translate the at least one slide relative to the base.

2. The bin slide assembly of claim 1, further comprising:
a first slide and a second slide; and
wherein the control assembly comprises a first electric motor and first screw operatively connected to the first slide, and a second electric motor and second screw operatively connected to the second slide.

3. The bin slide assembly of claim 2, wherein the first slide and the second slide translate substantially parallel to one another.

4. The bin slide assembly of claim 3, wherein each of the first and second slides comprise a slide block in engagement with the first and second screws.

5. The bin slide assembly of claim 1, wherein the electric motor comprises an output shaft having a gear.

6. The bin slide assembly of claim 5, wherein the control assembly further comprises a second gear, said second gear connected to the screw such that rotation of the second gear causes corresponding rotation of the screw.

7. The bin slide assembly of claim 1, wherein the electric motor comprises a brushed DC motor.

8. The bin slide assembly of claim 1, wherein the screw comprises an acme screw.

9. The bin slide assembly of claim 8, wherein rotation of the acme screw moves the slide 2-mm per rotation of said acme screw.

10. The bin slide assembly of claim 1, wherein the electric motor comprises an electric actuator having a threaded rod.

11. The bin slide assembly of claim 10, wherein the control assembly further comprises a worm gear operatively connected to the threaded rod of the electric actuator and the at screw, wherein extension of the electric actuator causes the worm gear and screw to rotate to translate the at least one slide.

12. A feed bin assembly, comprising:
a feed bin comprising a housing with an outlet at or near the bottom of the housing; and
a bin slide assembly at the outlet of the feed bin to control the output of particulate material from the feed bin, the bin slide assembly comprising:
at least one slide translationally connected to the base; and
a control assembly for translating the at least one slide, the control assembly comprising:
an electric motor; and
a screw operatively connected to the electric motor and the at least one slide, said operation of the electric motor causing rotation of the screw to translate the at least one slide relative to the base;
wherein operation of the at least one slide controls the output of the particulate material into a feed line.

13. The feed bin assembly of claim 12, wherein the feed bin further comprises a feed boot and an unloader at the outlet.

14. The feed bin assembly of claim 13, wherein the unloader at least partially encloses the bin slide assembly.

15. The feed bin assembly of claim 12, further comprising a second bin slide assembly positioned at the outlet of the feed bin.

16. The feed bin assembly of claim 15, wherein the second bin slide assembly is positioned side-by-side to the bin slide assembly.

17. The feed bin assembly of claim 12, wherein the rotation of the screw in a first direction translates the at least one slide away from the motor, and rotation of the screw in a second direction translates the at least one slide towards the motor.

18. A method of opening and closing a bin slide assembly, the method comprising:
rotating a member in a first direction with a motor, wherein the first direction causes a linear movement of a cover away from the motor; and
rotating the member in a second direction with the motor, wherein the second direction causes a linear movement of the cover towards the motor.

19. The method of claim 18, wherein the rotating member comprises a screw.

20. The method of claim 18, further comprising automatically stopping the linear movement of the cover at a distance from the motor.
